(19) United States
(12) Patent Application Publication
(10) Pub. No.: US 2011/0259855 A1
(43) Pub. Date: Oct. 27, 2011

(54) Plasma Torch Electrode with Improved Cooling Capability

(75) Inventor: Yong Yang, Hanover, NH (US)

(73) Assignee: HYPERTHERM, INC., Hanover, NH (US)

(21) Appl. No.: 13/090,044

(22) Filed: Apr. 19, 2011

Related U.S. Application Data
(60) Provisional application No. 61/342,932, filed on Apr. 21, 2010.

(51) Int. Cl. B23K 9/00

(52) U.S. Cl. 219/121.5; 219/121.52

(57) ABSTRACT

An electrode for a plasma arc torch includes a hollow elongated body having an open end and a closed end and an end face located at the closed end inside of the hollow elongated body. The end face has a center portion. A plurality of heat exchanging elements are in thermal communication with the end face. The heat exchanging elements have side walls defining an elongated channel between adjacent heat exchanging elements. The elongated channel extends radially from the center portion to an inner surface of the elongated body. The elongated channel provides a thermally conductive path that transfers sufficient heat from the elongated body to a cooling fluid during an operation of the plasma arc torch to prevent premature failure of the electrode.

### RELATED APPLICATIONS

This application claims the benefit of and priority to U.S. Provisional Application No. 61/342,932, filed Apr. 21, 2010, the entirety of which is hereby incorporated herein by reference.

### TECHNICAL FIELD

The present invention relates generally to plasma arc cutting torches, and more particularly, to a plasma torch electrode designed to provide an improved cooling capability.

### BACKGROUND

Plasma arc torches are widely used for cutting metallic materials and can be employed in mechanized systems for automatically processing a workpiece. The system can include the plasma arc torch, an associated power supply, a positioning apparatus and an associated controller. At least one of the plasma arc torch and the workpiece can be mounted on the positioning apparatus which provides relative motion between the torch and the workpiece to direct the plasma arc along a processing path.

A plasma torch generally includes an electrode, and a nozzle having a central exit orifice mounted within a torch body, electrical connections, passages for cooling, passages for arc control fluids (e.g., plasma gas), and a power supply. A swirl ring can be employed to control fluid flow patterns in the plasma chamber formed between the electrode and nozzle. The torch produces a plasma arc, a constricted ionized jet of a gas with high temperature and high momentum. Gases used in the torch can be non-reactive (e.g., argon or nitrogen) or reactive (e.g., oxygen or air). In operation, a pilot arc is first generated between the electrode (cathode) and the nozzle (anode). Generation of the pilot arc can be, for example, by means of a high frequency, high voltage signal coupled to a DC power supply and the torch.

Certain components of a plasma arc torch deteriorate over time from use. These “consumable” components include the electrode, swirl ring, nozzle, and shield. Ideally, these components are easily replaceable in the field. Nevertheless, the ability to effectively and efficiently cool these consumables within the torch is critical to ensure reasonable consumable life and cut quality.

Short electrode life due to high erosion rate (e.g., when the plasma arc torch is operated at greater than about 350 Amps) is a common problem for many mechanized plasma arc cutting systems. This short electrode life is mainly caused by the limitations of cooling at the electrode as well as material properties of the electrode. The cooling fluid (e.g., a liquid or a gas) must remove heat from the electrode by providing sufficient cooling to obtain acceptable electrode life. For example, electrode wear typically results in reduced quality cuts. The kerf width dimension may increase or the cut angle may move out of square as electrode wear increases. This requires frequent replacement of the electrode to achieve suitable cut quality.

In addition, the alignment of these consumable components, particularly the alignment of the electrode and cooling tube, within the plasma arc torch is essential to ensure reasonable consumable life as well as accuracy and repeatability of plasma arc location, which is important in automated plasma arc cutting systems. Repeated use of a torch having a coolant tube misaligned with the electrode causes the insert material (e.g., hafnium) to rapidly wear away resulting in reduced quality cuts.

### SUMMARY OF THE INVENTION

What is needed is an electrode that has superior cooling capabilities over existing electrodes and can improve the local cooling at the tip of the electrode significantly without changing the existing coolant flow within the torch. In addition, the improved electrode should be configured to align with the cooling tube so as to maintain the integrity of the electrode and the quality of the cut over many starts of the torch.

In one aspect, the invention features an electrode for a plasma arc torch including a hollow elongated body having an open end and a closed end and an end face located at the closed end inside of the hollow elongated body. The end face has a center portion. A plurality of heat exchanging elements are in thermal communication with the end face. The heat exchanging elements have side walls defining an elongated channel between adjacent heat exchanging elements. The elongated channel extends radially from the center portion to an inner surface of the elongated body. The elongated channel provides a thermally conductive path that transfers sufficient heat from the elongated body to a cooling fluid during an operation of the plasma arc torch to prevent premature failure of the electrode.

In another aspect the invention features an electrode for a plasma arc torch including a hollow elongated body having an open end, a closed end and an inner surface and an end face located at the closed end inside of the hollow elongated body. The end face has a central region. At least two extended heat exchanging elements are in direct thermal communication with the inner surface of the elongated body. The extended heat exchanging elements have side walls defining an elongated groove between adjacent extended heat exchanging elements. The elongated groove extends axially from the closed end to the open end.

In another aspect, the invention features a plasma arc torch system including an electrode disposed within a torch body. The electrode includes a hollow elongated body having an open end and a closed end and an end face located at the closed end inside of the hollow elongated body. The end face has a center portion. A plurality of heat exchanging elements are in thermal communication with the end face. The heat exchanging elements have side walls defining an elongated channel between adjacent heat exchanging elements. The elongated channel extends radially from the center portion to an inner surface of the elongated body. The elongated channel provides a thermally conductive path that transfers sufficient heat from the elongated body to a cooling fluid during an operation of the plasma arc torch to prevent premature failure of the electrode. The plasma arc torch system also includes a cooling tube disposed at least partially within the hollow elongated electrode body. The cooling tube includes an elongated body having a coolant passage extending therethrough, wherein the cooling tube is aligned radially with the at least two heat exchanging elements of the electrode.

In another aspect, the invention features an electrode for a plasma arc torch. The electrode includes a hollow elongated body having an open end and a closed end. The body includes a longitudinal axis that extends through the open and closed ends. An end face is located inside of the hollow elongated body at the closed end. The end face has a central region. A plurality of heat exchanging elements are in thermal communication with the end face. The heat exchanging elements have opposing side walls that define an elongated channel between adjacent heat exchanging elements. The elongated channel extends in a transverse direction relative to the longitudinal axis and provides a thermally conductive path that transfers heat from the elongated body to a cooling gas flowing through the elongated channel during an operation of the plasma arc torch.

In some embodiments the electrode also includes a cooling post formed of a thermally conductive material and disposed at the center portion of the end face. The elongated channel can extend from a surface of the cooling post to the inner surface of the elongated body. In some embodiments, the elongated channel extends in a transverse direction relative to a longitudinal axis extending through the open and the closed end of the elongated body of the electrode.

The electrode can also includes at least two extended heat exchanging elements in thermal communication with the inner surface of the elongated body. In some embodiments, the at least two extended heat exchanging elements in thermal communication with the inner surface of the elongated body define an elongated groove between adjacent extended heat exchanging elements. The elongated groove can extend from the closed end toward the open end of the hollow elongated body.

The elongated body can be dimensioned to receive a cooling tube that (a) aligns axially with the plurality of heat exchanging elements located inside the closed end in thermal communication with the end face and (b) aligns radially with the at least two extended heat exchanging elements in thermal communication with the inner surface of the elongated body.

In some embodiments, the at least two extended heat exchanging elements in thermal communication with the inner surface of the elongated body are formed by an extrusion process. In some embodiments, the at least two extended heat exchanging elements in thermal communication with the inner surface of the elongated body are formed by a stamping process.

The elongated channel can be curved. In some embodiments, the elongated channel is canted. The elongated channel can extend substantially continuously to the elongated groove.

The elongated groove can be curved. In some embodiments, the elongated groove forms a spiral groove along the inner surface of the elongated body.

In some embodiments, the extended heat exchanging elements and the elongated groove extend radially along the end face. The heat exchanging elements can be in direct thermal communication with the inner surface and the end face of the elongated body. In some embodiments, the at least two extended heat exchanging elements are formed by a stamping process.

The elongated groove can provide a thermally conductive path that transfers sufficient heat from the elongated body to a cooling fluid during an operation of the plasma arc torch to prevent premature failure of the electrode.

The plasma arc torch system can also include a nozzle disposed relative to the electrode at a distal end of the torch body to define a plasma chamber. In some embodiments, the plasma arc torch system includes a shield disposed relative to an exterior surface of the nozzle at a distal end of the torch body.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic illustration of an automated plasma arc torch system.

FIG. 2 is a cross-sectional view of an electrode, according to an illustrative embodiment of the invention.

FIG. 3A is a perspective view of an end face of an electrode, according to an illustrative embodiment of the invention.

FIG. 3B is a cross sectional view of an end face of an electrode, according to an illustrative embodiment of the invention.

FIG. 4A is a perspective view of an end face of an electrode, according to an illustrative embodiment of the invention.

FIG. 4B is a cross sectional view of an end face of an electrode, according to an illustrative embodiment of the invention.

FIG. 4C is a top view of an end face of an electrode, according to an illustrative embodiment of the invention.

FIG. 5A is a perspective view of an interior surface of an electrode, according to an illustrative embodiment of the invention.

FIG. 5B is a perspective view of an interior surface of an electrode having angled extended heat exchanging elements, according to an illustrative embodiment of the invention.

FIG. 6 is a perspective view of a cooling tube, according to an illustrative embodiment of the invention.

FIG. 7 is a comparison graph of electrode pit depth versus number of arc starts for a Hypertherm electrode made according to an illustrative embodiment of the invention and an electrode made by a first competitor.

FIG. 8 is a comparison graph of electrode pit depth versus number of arc starts for a Hypertherm electrode made according to an illustrative embodiment of the invention and an electrode made by a second competitor.

FIG. 9 is a graph of the quality of an electrode during its lifetime, according to an illustrative embodiment of the invention.

### DETAILED DESCRIPTION

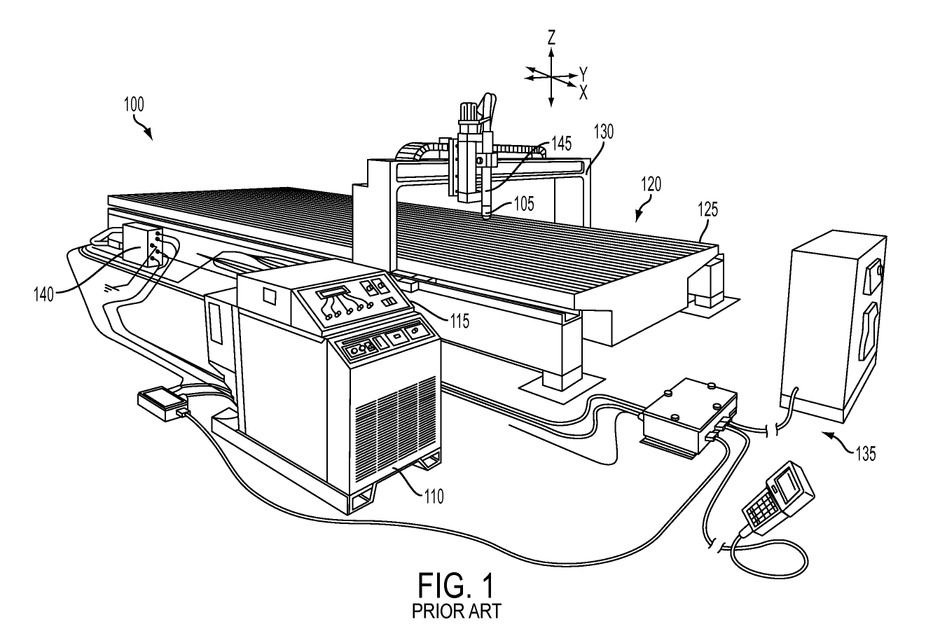

FIG. 1 shows a prior art mechanized plasma arc system 100. The system 100 includes a plasma arc torch 105 with an associated power supply 110 and a gas console 115 for generating a plasma arc. A positioning apparatus 120 includes a generally planar table 125 for fixturing of a workpiece (not shown), an overlaying gantry 130 having three motorized, mutually orthogonal linear axes X, Y, and Z with the torch 105 mounted on the Z axis, and a suitable controller 135 with three axis drives. The system also includes a high frequency, high voltage console 140 for generating a pilot arc in the torch 105. A connector system can be used to removably couple the torch 105 to a receptacle 145. The torch 105 contains consumable components, e.g., an electrode, nozzle, shield, and/or swirl ring. Proper cooling of these consumables, and in particular of the electrode, is required to maintain the quality of the cut and to prevent premature failure of the consumables.

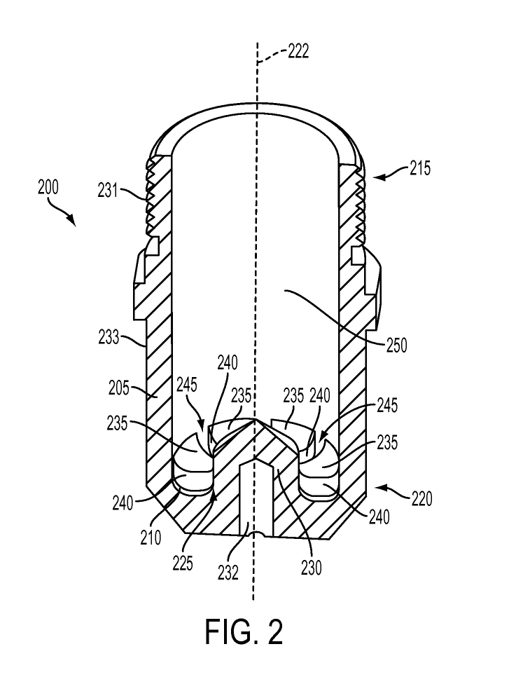

FIG. 2 shows a cross-section of an electrode 200 illustrative of the invention. The electrode 200 has a hollow elongated body 205 and an end face 210. The hollow elongated body 205 has an open end 215 and a closed end 220. A longitudinal axis 222 can extend through the open and closed ends 215, 220, respectively. The end face 210 is located at the closed end 220 inside of the hollow elongated body 205. The end face 210 has a center portion or region 225 which can be, for example, a cooling post 230. Threads 231 can be disposed along an exterior surface 233 of the elongated body 205 at or near the open end 215 of the electrode 200 for replaceably securing the electrode 200 in a cathode block of a plasma arc torch (e.g., torch 105 of FIG. 1).

A bore 232 can be drilled into the closed end 220 along the longitudinal axis 222. A generally cylindrical insert (not shown) formed of a high thermionic emissivity material (e.g., hafnium) can be press fit in the bore 232. The insert can extend axially through the closed end 220 along the longitudinal axis 222 to a hollow interior of the elongated electrode body 205. An emission surface (not shown) can be located along a face of the insert and can be exposable to a plasma gas in the torch. The emission surface can be initially planar or can be initially shaped to define a recess in the insert.

A plurality of heat exchanging elements 235 are formed within the hollow interior in thermal communication with the end face 210. For example, the heat exchanging elements 235 can be in direct thermal communication with (e.g., in direct contact with or touching) the end face 210. The heat exchanging elements 235 have side walls 240 that define an elongated channel 245 between adjacent heat exchanging elements 235. The elongated channel 245 extends radially (e.g., extends in a transverse direction relative to the longitudinal axis 222) from the center portion or region 225 to an inner surface 250 of the elongated body 205. The elongated channel 245 provides a thermally conductive path that transfers sufficient heat from the elongated body 205 to a cooling fluid during an operation of the plasma arc torch (e.g., torch 105 of FIG. 1) to prevent premature failure of the electrode 200.

In some embodiments, the cooling post 230 is formed of a thermally conductive material, for example, copper. The cooling post 230 can be disposed at the center portion or region 225 of the end face 210. The elongated channel 245 can extend from a surface of the cooling post 230 to the inner surface 250 of the elongated body 205. The elongated channel 245 can extend radially from a surface of the cooling post 230 to the inner surface 250 of the elongated body 205.

The plurality of heat exchanging elements 235, which form an elongated channel 245 between adjacent heat exchanging elements 235, provide additional surface area at the end face 210 of the electrode 200 so that cooling fluid can flow over the heat exchanging elements 235 and/or through the elongated channel 245. The additional surface area provided by the heat exchanging elements 235 and/or elongated channel 245 can increase the amount of cooling of the electrode 200 at the end face 210. A higher surface area can result in a greater amount of heat being transferred between the heat exchanging elements 235 and/or elongated channel 245 and the cooling gas. For example, the heat can transfer between the heat exchanging elements 235 and/or elongated channel 245 to the cooling gas by conductive and/or convective heat transfer. The greater the surface area provided at the end face 210 of the electrode 200, the greater the amount of heat transfer extending the service life of the electrode 200 and reducing the likelihood of premature failure.

In some embodiments, the elongated body 205 is dimensioned to receive a cooling tube (not shown) that aligns axially with the plurality of heat exchanging elements 235 that are located inside the closed end 220 in thermal communication with the end face 210. For example, the elongated body 205 can have a diameter of about 0.25″ to about 0.75″ and a length of about 0.25″ to about 2″. The cooling tube can have an inner diameter of about 0.15″ to about 0.5″.

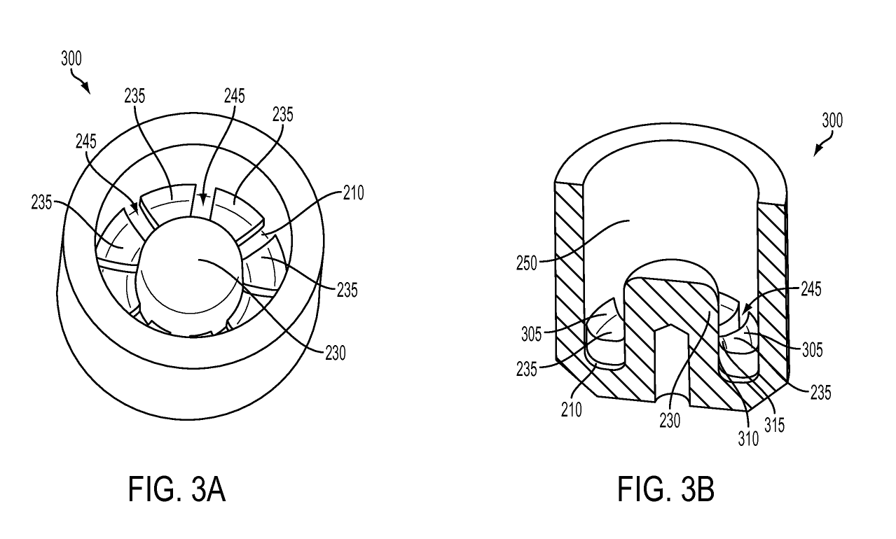

FIG. 3A shows a perspective view of an end face 210 of an electrode 300 and FIG. 3B shows a cross sectional view of the end face 210 of the electrode 300. Only the bottom half of the electrode 300 is shown in FIGS. 3A and 3B. The heat exchanging elements 235 and the elongated channel 245 can be equally spaced around the central region or cooling post 230. In some embodiments, the heat exchanging elements 235 and the elongated channel 245 are not equally spaced around the central region or cooling post 230. The spacing of the heat exchanging elements 235 and the elongated channel 245 can depend upon the specific cooling needs (e.g., to prevent premature failure of the electrode) of the electrode 300 and/or plasma arc torch or the surface area required to meet those cooling needs. The configuration of such heat exchanging elements 235 and the elongated channel 245 can depend greatly upon the specific plasma torch design. For a specific application, the heat exchanging elements can be modeled using convention fluid modeling software. In some embodiments, the specific configuration of the heat exchanging elements 235 and the elongated channel 245 depends on the alignment features of a cooling tube that can be disposed within the hollow, elongated body of the electrode 300.

Referring to FIG. 3B, the heat exchanging elements 235 can be connected curvilinearly to the inner surface 250 of the electrode body. In some embodiments, the heat exchanging elements 235 are integrally formed with the electrode body (e.g., through a stamping or a hot or cold extruding process) and the heat exchanging elements 235 have a curvilinear (e.g., rounded) surface 305 at and/or near where the heat exchanging element 235 joins with the inner surface 250 of the electrode body. The curvilinear surface 305 can increase the surface area of the heat exchanging elements 235 to provide additional heat transfer between the heat exchanging elements 235 and/or the elongated channel 245 and the cooling gas. The curvilinear surface 305 can also direct the cooling gas flow to flow along the end face 210, heat exchanging elements 235, and elongated channel 245 and then up the inner surface 250 of the electrode 300. In some embodiments, the curvilinear surface 305 can be an alignment feature that can properly axially align a cooling tube (not shown) that is disposed within the hollow elongated electrode body.

The heat exchanging elements 235 can also be connected curvilinearly to a surface 310 of the cooling post 230. The heat exchanging elements 235 can have a curvilinear surface 315 at and/or near where the heat exchanging element 235 joins with the surface 310 of the cooling post 230. Similar to curvilinear surface 305, curvilinear surface 310 can increase the surface area of the heat exchanging elements 235 to provide additional heat transfer between the heat exchanging elements 235 and/or the elongated channel 245 and the cooling gas. The curvilinear surface 310 can also direct the cooling gas flow from a cooling tube (not shown) to flow along the end face 210, heat exchanging elements 235, and elongated channel 245 to obtain increased heat transfer between the heat exchanging elements 235 and the cooling gas and to increase the overall service life of the electrode 300. In some embodiments, the curvilinear surface 310 can be an alignment feature that can properly align a cooling tube (not shown) that is disposed within the hollow elongated electrode body. For example, the curvilinear surfaces 305, 310 can axially align a cooling tube that is received by the elongated body of the electrode 300.

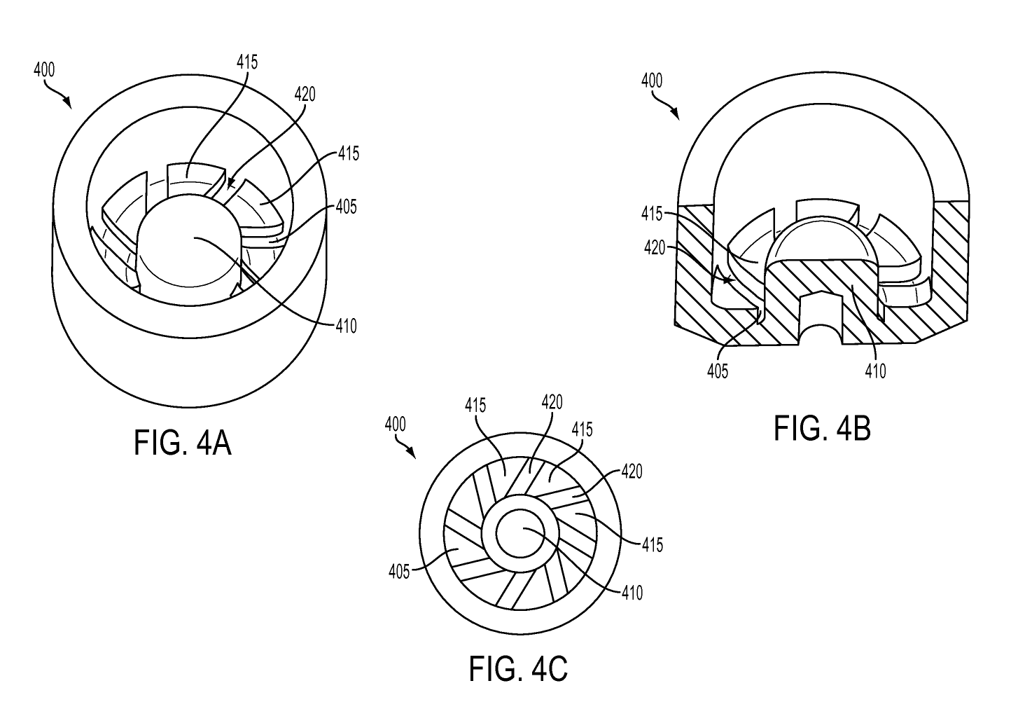

FIG. 4A is a perspective view of an end face 405 of an electrode 400, FIG. 4B is a cross sectional view of the end face 405 of the electrode 400, and FIG. 4C is a top view of the end face 405 of the electrode 400. Similar to FIGS. 3A and 3B, the electrode 400 includes a cooling post 410, heat exchanging elements 415, and elongated channels 420. As shown in FIGS. 4A-C, the heat exchanging elements 415 and elongated channels 420 can be equally spaced around the cooling post 410 and oriented off center, for example, the elongated channels 420 can be canted (e.g., positioned at an angle relative to a central region of the end face 405). The off-center distance or angle can be calculated through the optimization of coolant flow and/or heat transfer by using calculation tools such as a computational fluid dynamics.

In some embodiments, the elongated channel is curved. An angled or curved elongated channel can increase the surface area of the heat exchangers, which results in a greater amount of cooling than an electrode with an elongated channel that is not angled or curved. For example, the heat exchanging elements 415 of FIGS. 4A-C can have a greater surface area than the heat exchanging elements 235 of FIGS. 3A-B. In addition, a heat exchanging element with curved sides (e.g., resulting in a curved elongated channel between adjacent heat exchanging elements), can have more surface area and greater heat transfer capabilities than a heat exchanging element with angled sides (e.g., resulting in an angled elongated channel between adjacent heat exchanging elements). In some embodiments, the elongated channel 420 forms a spiral groove around the cooling post 410 and end face 405 of the electrode 400. The heat exchanging elements and resulting elongated channel between two adjacent heat exchanging elements can have any shape or size that adequately cools an electrode and/or provides proper alignment of a cooling tube disposed within the hollow elongated body of an electrode.

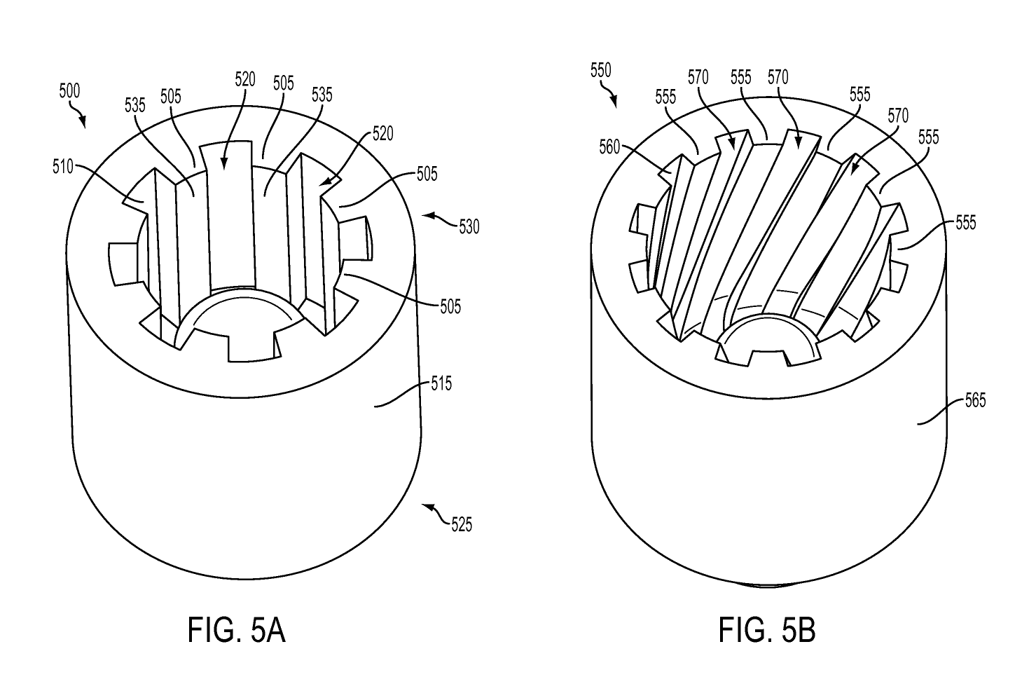

FIG. 5A shows an electrode 500 having at least two extended heat exchanging elements 505 in thermal communication with the inner surface 510 of the elongated body 515 of the electrode 500. For example, the extended heat exchanging elements 505 can be in contact with or touch the inner surface 510 of the electrode 500. The extended heat exchanging elements 505 can define an elongated groove 520 between two adjacent heat exchanging elements 505. The extended heat exchanging elements 505 and the elongated groove 520 can extend from the closed end 525 of the electrode 500 to the open end 530 of the electrode 500. In some embodiments, the extended heat exchanging elements 505 and the elongated groove 520 extend partially up the inner surface 510 of the electrode and do not extend completely to the open end 530 of the electrode 500.

The elongated groove 520 can provide a thermally conductive path that transfers sufficient heat from the elongated body 515 to a cooling fluid during an operation of the plasma arc torch to prevent premature failure of the electrode 500. The heat transferred from the elongated body to a cooling fluid enhances the cooling at the closed end 525 of the electrode 500. The cooling fluid can maintain the temperature of the electrode below the melting temperature of the electrode material (e.g., copper), while being not so cool as to prevent the thermionic emitter from operating efficiently (e.g., a hot Hafnium thermionic emitter can efficiently emit an arc from the plasma arc torch, while a cooler Hafnium thermionic emitter will not be as efficient).

The elongated body 515 can be dimensioned to receive a cooling tube (not shown). The cooling tube can radially align with the at least two extended heat exchanging elements 505. For example, an outer surface of the cooling tube can radially align with an inner surface 535 of the extended heat exchanging element 505. For example, the outer surface of the cooling tube can come into direct contact with the inner surface 535 of the extended heat exchanging element 505. In some embodiments, the inner surfaces 535 of the extended heat exchanging elements 505 form an inner diameter of the electrode 500 and the outer surface of the cooling tube can have an outer diameter. The outer diameter of the cooling tube can be substantially the same as the inner diameter of the electrode 500. For example, the outer diameter of the cooling tube can be the same as the inner diameter of the electrode. In some embodiments, the outer diameter of the cooling tube can be about zero to about 0.3″ less than the inner diameter of the electrode 500.

FIG. 5B shows an electrode 550 having at least two extended heat exchanging elements 555 in thermal communication with the inner surface 560 of the elongated body 565 of the electrode 550. The extended heat exchanging elements 555 can define an elongated groove 570 between two adjacent heat exchanging elements 555. The heat exchanging elements 555 and the elongated groove 570 can be angled or curved. An angled or curved elongated groove 570 and/or heat exchanging element 555 can provide for increased surface area as compared to the straight elongated groove 520 and extended heat exchanging element 505 of FIG. 5A. An increased surface area can result in the better heat transfer properties of the electrode 550 and longer electrode life. In some embodiments, the elongated groove 570 forms a spiral groove along the inner surface 560 of the elongated body 565. The extended heat exchanging elements 505, 555 can be any size or shape that provides sufficient cooling to prevent premature failure of the electrode 500, 550 and/or properly aligns a cooling tube within the hollow elongated body of the electrode 500, 550.

An electrode can have either the heat exchanging elements as shown in FIGS. 2, 3A-B, or 4A-C or the extended heat exchanging elements of FIGS. 5A-B. In some embodiments, an electrode includes both the heat exchanging elements as shown in FIGS. 2, 3A-B, or 4A-C as well as the extended heat exchanging elements of FIGS. 5A-B. For example, the elongated channel 245 of FIG. 2 can extend substantially, continuously to the elongated groove 520 of FIG. 5A. In other words, a channel can extend along an end face of an electrode and continue up along an interior surface of an electrode body, forming a continuous channel from the end face at a closed end of the electrode to the open end of the electrode. Similarly, a heat exchanging element can extend along an end face of an electrode and continue up along an interior surface of an electrode body forming a continuous heat exchanging element that is in direct thermal communication with the end face at a closed end of the electrode and is also in direct thermal communication with the interior surface of the electrode body.

Referring to FIGS. 5A and 5B, in some embodiments, the extended heat exchanging elements 505, 555 in thermal communication with the inner surface of the elongated body 515, 565 are formed by an extrusion process. In an extrusion process, the extended heat exchanging elements 505, 555 of the elongated body 515, 565 can be formed in the interior of the electrode by the shape of the extrusion die. Once the body 515, 565 and the extended heat exchanging elements 505, 555 are formed, the closed end of the electrode (formed by a different process, for example, a stamping process or are machined) can be attached to the hollow elongated body 515, 565 by any number of known bonding processes (e.g., welding). This can permit the internal extended heat exchanging elements 505, 555 to be made inexpensively.

In some embodiments, the extended heat exchanging elements 505, 555 in thermal communication with the inner surface of the elongated body 515, 565 are formed by a stamping process. In a stamping process, the extended heat exchanging elements 505, 555 and the heat exchange elements 515, 565 can be formed in the hollow elongated body 515, 565 by a stamp pressed against an electrode blank. Such a process can minimize or eliminate the need to machine internal features in the interior of an electrode.

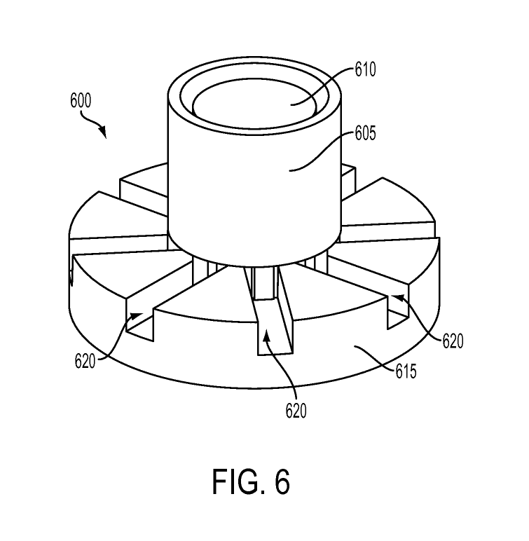

Any of the electrode designs described herein can be used in a plasma arc torch system, for example, the plasma arc torch system of FIG. 1. In addition to the electrode, the plasma arc torch system can also include a cooling tube. FIG. 6 shows a cooling tube 600 for use in a plasma arc torch system. The cooling tube 600 can be disposed at least partially within a hollow elongated body of an electrode and can be replaceably secured in a torch (not shown) by threads or an interference fit. The cooling tube 600 can comprise an elongated body 605 with a coolant passage 610 extending therethrough. The cooling tube 600 can be aligned radially with at least two heat exchanging elements of an electrode, for example, heat exchanging elements 235 of FIG. 2 or heat exchanging elements 415 of FIGS. 4A-C. The cooling tube can contact the at least two heat exchanging elements of the electrode and can also contact the extended heat exchanging elements of FIGS. 5A-C. Because of the heat exchanging elements and extended heat exchanging elements can align the cooling tube 600 within the electrode, there is no need for the cooling tube 600 to have a separate mating surface, as described in U.S. Patent Publication No. 2008/0116179 to Hypertherm, Inc., the entire contents of which is incorporated herein by reference.

The cooling tube 600 can have a bottom section 615 that can be designed to have features 620 matching the elongated channels of an electrode. The features 620 can allow cooling fluid that flows through elongated channels of the electrode to continue to flow through the features 620 of the cooling tube, which can maximize the cooling function of the cooling tube and cooling fluid (e.g., water).

The plasma arc torch system can also include a nozzle disposed relative to the electrode at a distal end of the torch body to define a plasma chamber. In some embodiments, a shield is disposed relative to an exterior surface of the nozzle at a distal end of the torch body.

Importantly, the plasma electrode having the heat exchanging elements and/or extended heat exchanging elements can directly replace existing, prior art electrodes without any change to the plasma arc torch system. Specifically, the coolant circulation system and setup does not have to change when the electrode of the present invention is substituted for prior art electrodes. Therefore, the cooling benefits of the present electrode can be realized without any other cost or changes to a consumers' existing plasma arc torch system.

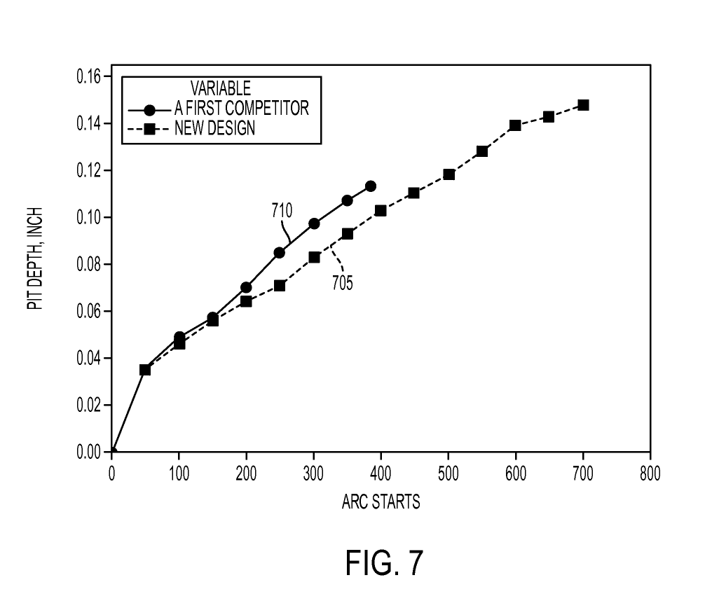

FIG. 7 shows graph of electrode pit depth versus number of arc starts for a Hypertherm electrode 705 made according to an illustrative embodiment of the invention and an electrode made by a first competitor 710. As shown in FIG. 7, the electrode of the present invention 705 can operate longer with a deeper pit depth than the electrode made by the first competitor 710. This indicates that the cooling design of the electrode of the present invention effectively cools the electrode to prevent premature consumable failure. The graph shows that the Hypertherm electrode 705 achieves about 700 arc starts and reaches a pit depth of about 0.14 inches while the first competitor's electrode 710 only achieves about 400 arc starts and reaches a pit depth of about 0.11 inches. The premature failure of the first competitor's electrode results in operators having to replace the electrode more frequently, which results in more expense and time needed to operate the plasma arc torch.

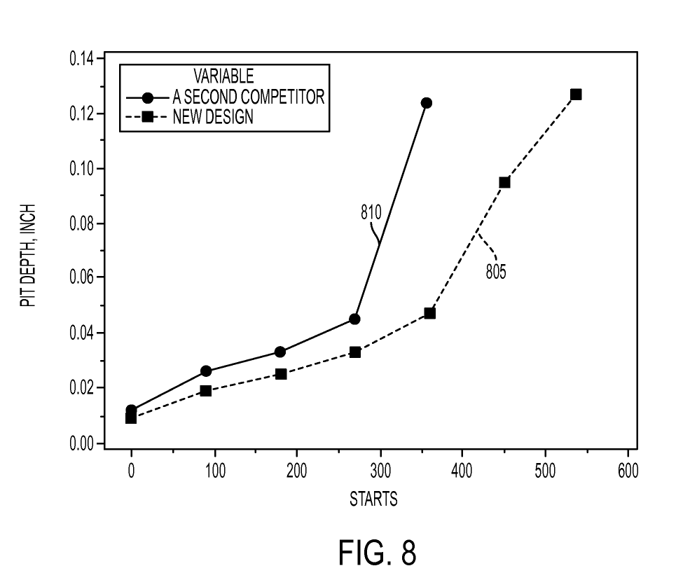

FIG. 8 shows a graph of electrode pit depth versus number of arc starts for a Hypertherm electrode 805 made according to an illustrative embodiment of the invention and an electrode made by a second competitor 810. As shown in FIG. 8, the electrode of the present invention 805 can operate longer than the electrode made by the second competitor 810. This indicates that the cooling design of the electrode of the present invention effectively cools the electrode to prevent premature consumable failure. The graph shows that the Hypertherm electrode 805 achieves about 550 arc starts and reaches a pit depth of about 0.12 inches while the second competitor's electrode 810 only achieves about 350 arc starts before it reaches a pit depth of about 0.12 inches. The premature failure of the second competitor's electrode results in operators having to replace the electrode more frequently, which results in more expense and time needed to operate the plasma arc torch.

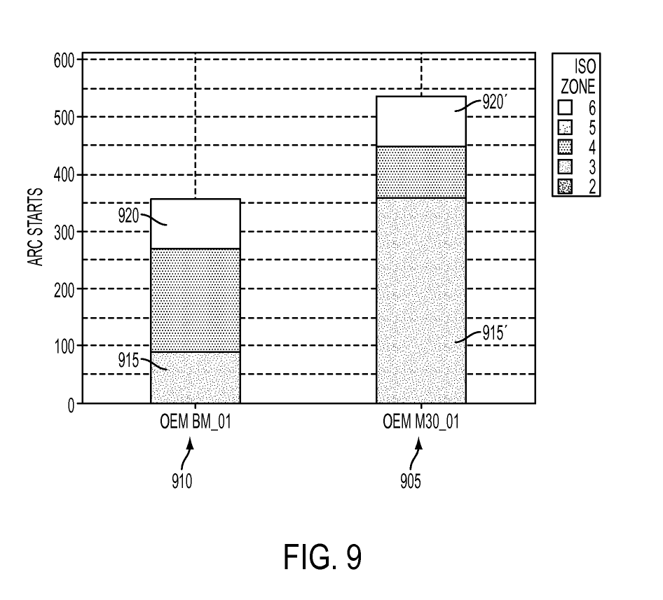

FIG. 9 shows a graph that depicts the quality of an electrode during its lifetime. An electrode having heat exchanging elements in thermal communication with an end face of an electrode 905 was compared against an electrode without heat exchanging elements in thermal communication with an end face of an electrode 910. The bottom section 915, 915′ of the graph indicates good cut quality while the upper section 920, 920′ indicates electrode failure. As shown, the electrode 905 of the present invention has good cut quality for about 350 starts of the plasma arc torch while the electrode 910 that does not incorporate the heat exchanging elements has good cut quality for about 90 starts of the plasma arc torch. In addition, the electrode 905 of the present invention does not fail until about 450-540 starts of the plasma arc torch while the electrode 910 that does not incorporate the heat exchanging elements fails after about 275-350 starts of the plasma arc torch. The electrode 905 of the present invention has more effective cooling through the use of the heat exchanging elements in thermal communication with the end face of the electrode, which results in a consumable that does not fail prematurely. In addition, an electrode that incorporates both heat exchanging elements in thermal communication with the end face of the electrode and extended heat exchanging elements in thermal communication with an inner surface of the electrode can show good cut quality for an even greater amount of plasma arc torch starts.

Although various aspects of the disclosed apparatus have been shown and described, modifications may occur to those skilled in the art upon reading the specification. The present application includes such modifications and is limited only by the scope of the claims.

What is claimed is:

1. An electrode for a plasma arc torch, the electrode comprising:
a hollow elongated body having an open end and a closed end;
an end face located at the closed end inside of the hollow elongated body, the end face having a center portion; and
a plurality of heat exchanging elements in thermal communication with the end face, the heat exchanging elements having side walls defining an elongated channel between adjacent heat exchanging elements, the elongated channel extending radially from the center portion to an inner surface of the elongated body, the elongated channel providing a thermally conductive path that transfers sufficient heat from the elongated body to a cooling fluid during an operation of the plasma arc torch to prevent premature failure of the electrode.

2. The electrode of claim 1, further comprising a cooling post formed of a thermally conductive material disposed at the center portion of the end face, the elongated channel extending from a surface of the cooling post to the inner surface of the elongated body.

3. The electrode of claim 1, further comprising at least two extended heat exchanging elements in thermal communication with the inner surface of the elongated body.

4. The electrode of claim 3, wherein the at least two extended heat exchanging elements in thermal communication with the inner surface of the elongated body define an elongated groove between adjacent extended heat exchanging elements, the elongated groove extending from the closed end toward the open end of the hollow elongated body.

5. The electrode of claim 3, wherein the elongated body is dimensioned to receive a cooling tube that (a) aligns axially with the plurality of heat exchanging elements located inside the closed end in thermal communication with the end face and (b) aligns radially with the at least two extended heat exchanging elements in thermal communication with the inner surface of the elongated body.

6. The electrode of claim 3, wherein the at least two extended heat exchanging elements in thermal communication with the inner surface of the elongated body are formed by an extrusion process.

7. The electrode of claim 3 wherein the at least two extended heat exchanging elements in thermal communication with the inner surface of the elongated body are formed by a stamping process.

8. The electrode of claim 1, wherein the elongated channel is curved.

9. The electrode of claim 1, wherein the elongated channel is canted.

10. The electrode of claim 4, wherein the elongated groove is curved.

11. The electrode of claim 4 wherein the elongated groove forms a spiral groove along the inner surface of the elongated body.

12. The electrode of claim 4 wherein the elongated channel extends substantially continuously to the elongated groove.

13. The electrode of claim 1 wherein the elongated channel extends in a transverse direction relative to a longitudinal axis extending through the open and the closed ends of the elongated body of the electrode.

14. An electrode for a plasma arc torch, the electrode comprising:
a hollow elongated body having an open end, a closed end and an inner surface;
an end face located at the closed end inside of the hollow elongated body, the end face having a central region; and
at least two extended heat exchanging elements in direct thermal communication with the inner surface of the elongated body, the extended heat exchanging elements having side walls defining an elongated groove between adjacent extended heat exchanging elements, the elongated groove extending axially from the closed end to the open end.

15. The electrode of claim 14, wherein the extended heat exchanging elements and the elongated groove extend radially along the end face, the heat exchanging elements in direct thermal communication with the inner surface and the end face of the elongated body.

16. The electrode of claim 14, wherein the elongated groove provides a thermally conductive path that transfers sufficient heat from the elongated body to a cooling fluid during an operation of the plasma arc torch to prevent premature failure of the electrode.

17. The electrode of claim 14 wherein the at least two extended heat exchanging elements are formed by a stamping process.

18. A plasma arc torch system comprising:
an electrode disposed within a torch body, the electrode comprising
a hollow elongated body having an open end and a closed end;
an end face located at the closed end inside of the hollow elongated body, the end face having a center portion; and
a plurality of heat exchanging elements in thermal communication with the end face, the heat exchanging elements having side walls defining an elongated channel between adjacent heat exchanging elements, the elongated channel extending radially from the center portion to an inner surface of the elongated body, the elongated channel providing a thermally conductive path that transfers sufficient heat from the elongated body to a cooling fluid during an operation of the plasma arc torch to prevent premature failure of the electrode; and
a cooling tube disposed at least partially within the hollow elongated electrode body, the cooling tube comprising an elongated body having a coolant passage extending therethrough, wherein the cooling tube is aligned radially with the at least two heat exchanging elements of the electrode.

19. The plasma arc torch system of claim 18 further comprising a nozzle disposed relative to the electrode at a distal end of the torch body to define a plasma chamber.

20. The plasma arc torch system of claim 19 further comprising a shield disposed relative to an exterior surface of the nozzle at a distal end of the torch body.
